(19) United States
(12) Patent Application Publication
(10) Pub. No.: US 2014/0164893 A1
(43) Pub. Date: Jun. 12, 2014

(54) ASSISTED PORTAL NAVIGATION AND CROWD-BASED FEEDBACK

(71) Applicants: Nissim Pariente, Kiryat-Ono (IL); Nimrod Barak, Tel Aviv (IL)

(72) Inventors: Nissim Pariente, Kiryat-Ono (IL); Nimrod Barak, Tel Aviv (IL)

(73) Assignee: SAP Portals Israel Ltd

(21) Appl. No.: 13/712,518

(22) Filed: Dec. 12, 2012

(51) Int. Cl. G06F 3/048

(52) U.S. Cl. CPC G06F 3/048
USPC 715/207

(57) ABSTRACT

The present disclosure describes methods, systems, and computer program products for assisted portal navigation and crowd-based feedback. One computer-implemented method includes processing, by operation of a computer, a hierarchy of container documents including a base-level container document and at least one active base-level content hyperlink and additional container documents associated with the at least one active base-level content hyperlink to: generate a site map specifying the hierarchy of container documents, and associate at least one generated graphical user interface (GUI) element with each container document in the hierarchy of container documents specified by the site map, receiving a hover detection event associated with the at least one active base-level content hyperlink, displaying a first-level pop-up container document including at least one first-level GUI element representing a particular additional container document associated with the one active base-level content hyperlink, and displaying a first-level detailed pop-up container document responsive to a detected hover event associated with one of the at least one first-level GUI element.

### BACKGROUND

The present disclosure relates to computer-implemented methods, computer-readable media, and computer systems for assisted portal navigation and crowd-based feedback. Portal users can retrieve and view information in a web-based portal with a web browser or a web-browsing software application. Web browsing operations typically include entering a uniform resource locator (URL) as an address in a web browser to navigate to a base-level (or “home”) portal page (one example of a container document) or by selecting active URL hyperlinks included on a particular portal container document. By selecting a successive series of hyperlinks, portal users can navigate within the portal's container documents. Portals often contain many container documents, each container document including many URLs/hyperlinks. Portal users must often navigate through many portal container documents to reach desired portal content; a complex, error prone, time consuming, inefficient, and frustrating method for portal navigation, especially if a portal user believes that the structure of the portal container documents could be modified to make portal navigation easier. Portal users, however, do not have an ability to suggest portal container document reorganization/restructuring to portal administrators. As a result, portal users find portal navigation difficult and unnecessarily complex, unnecessary portal container document maintenance is performed, and portal administrators are prevented from receiving constructive feedback from portal users to improve navigation in a portal.

### SUMMARY

The present disclosure relates to computer-implemented methods, computer-readable media, and computer systems for assisted portal navigation and crowd-based feedback One computer-implemented method includes processing a hierarchy of container documents including a base-level container document and at least one active base-level content hyperlink and additional container documents associated with the at least one active base-level content hyperlink to: generate a site map specifying the hierarchy of container documents, and associating at least one generated graphical user interface (GUI) element with each container document in the hierarchy of container documents specified by the site map, receiving a hover detection event associated with the at least one active base-level content hyperlink, displaying a first-level pop-up container document including at least one first-level GUI element representing a particular additional container document associated with the one active base-level content hyperlink, and displaying a first-level detailed pop-up container document responsive to a detected hover event associated with one of the at least one first-level GUI element.

Other implementations of this aspect include corresponding computer systems, apparatuses, and computer programs recorded on one or more computer storage devices, each configured to perform the actions of the methods. A system of one or more computers can be configured to perform particular operations or actions by virtue of having software, firmware, hardware, or a combination of software, firmware, or hardware installed on the system that in operation causes or causes the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination:

A first aspect, combinable with the general implementation, wherein the particular additional container document is at a lower hierarchy level in the container document site map than the base-level container document.

A second aspect, combinable with any of the previous aspects, wherein metrics data associated with a source of a detected particular hover event is updated responsive to the detected particular hover event.

A third aspect, combinable with any of the previous aspects, wherein the first-level detailed pop-up container document includes a reduced-size representation of a first container document associated with the at least one first-level GUI element.

A fourth aspect, combinable with any of the previous aspects, wherein the reduced-size representation contains at least one active second-level content hyperlink to a second container document at a lower hierarchy level in the container document site map than the first container document associated with the reduced size representation.

A fifth aspect, combinable with any of the previous aspects, further comprising displaying a second pop-up container document responsive to a received hover event associated with the at least one active second-level content hyperlink, wherein the second pop-up container document includes at least one second level GUI element.

A sixth aspect, combinable with any of the previous aspects, wherein a particular GUI element associated with a first particular level pop-up container document is movable to a second particular level pop-up container document, and wherein the first particular level and the second particular level are different.

A seventh aspect, combinable with any of the previous aspects, wherein moving the GUI element associated with the first particular level pop-up container document to the second particular level pop-up container document generates a request to restructure the container document site map.

An eighth aspect, combinable with any of the previous aspects, further comprising updating metrics data associated with the GUI element responsive to moving the GUI element.

A ninth aspect, combinable with any of the previous aspects, further comprising determining that the container document site map should be restructured based upon the updated metrics data.

A tenth aspect, combinable with any of the previous aspects, wherein the determination is based upon at least one updated value of the metrics data exceeding a threshold value.

An eleventh aspect, combinable with any of the previous aspects, further comprising: reprocessing the hierarchy of container documents, and generating an updated container document site map.

The subject matter described in this specification can be implemented in particular implementations so as to realize one or more of the following advantages. First, informational pop-up container documents can provide a portal user a graphical view of portal container document content associated with an active content hyperlink and allow a user to decide whether to navigate a successive portal container document using the active content hyperlink. Second, a reduced-size pop-up container document can provide the portal user a more detailed view of portal content associated with the active content hyperlink to assist the portal user is deciding if they wish to navigate to a specific portal container document. Third, in order to provide an efficient navigation experience, hyperlinks and/or content associated with each active content hyperlink is pre-calculated and capable of being instantaneously display in the reduced-size pop-up container document. Fourth, the suggested mechanism encapsulates an inherent capability to count a number of visits for each active content link. This information may provide portal administration quantitative/statistical information about the active content link. Based on this information, administrative can decide whether to move the active content link to a different location in the portal container document hierarchy. Fifth, based on the popularity of an active content hyperlink, the portal can also make automatic adjustments to the location of the active content link in the portal container document hierarchy. Sixth, portal users are provided an ability to suggest reorganization of portal container documents using a graphical user interface as part of a crowd source recommendation feature. Seventh, the crowd source feature can also be used to provide most recently browsed recommendations to portal users. For example, the portal can automatically provide a page with all recently visited/suggested active content hyperlinks. The portal can also make other suitable recommendations based upon gathered data and/or crowd sourced data. Other advantages will be apparent to those skilled in the art.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 is a block diagram illustrating an example distributed computing system for assisted portal navigation and crowd-based feedback.

FIG. 2 is a block diagram illustrating a base-level container document and an associated first-level pop-up container document.

FIG. 3 is a block diagram illustrating the first-level pop-up container document and an associated first-level detailed pop-up container document.

FIG. 4 is a block diagram illustrating the first-level detailed pop-up container document and a second-level pop-up container document.

FIG. 5 is a block diagram illustrating the second-level pop-up container document and an associated second-level detailed pop-up container document.

FIG. 6 is a block diagram illustrating the first-level pop-up container document and the second-level pop-up container document used in a crowd-based feedback operation.

FIG. 7 is a block diagram illustrating container documents pinned to a desktop.

FIG. 8 is a flow chart illustrating a method for assisted portal navigation.

FIG. 9 is a flow chart illustrating a method for providing crowd-based feedback during assisted portal navigation.

Like reference numbers and designations in the various drawings indicate like elements.

### DETAILED DESCRIPTION

This disclosure generally describes computer-implemented methods, computer-program products, and systems for assisted portal navigation and crowd-based feedback.

For the purposes of this disclosure, an enterprise portal (EP) is a framework for integrating information, people, and processes across organizational boundaries. An EP provides a secure unified access point, often in the form of a web-based user interface, and is designed to aggregate and personalize information through application-specific portals. The EP is a de-centralized content contribution and content management system, which keeps the information always updated. With only a web browser, EP users can begin work once they have been authenticated in the EP which offers a single point of access to information, enterprise applications, and services both inside and outside an organization. EPs may present information from diverse sources on mobile or other devices in a unified and structured way, for example using HTML container documents, and provide additional services, such as dashboards, an internal search engine, e-mail, news, navigation tools, and various other features. EPs are often used by enterprises for providing their employees, customers, and possibly additional users with a consistent look and feel, and access control and procedures for multiple applications, which otherwise would have been separate entities altogether.

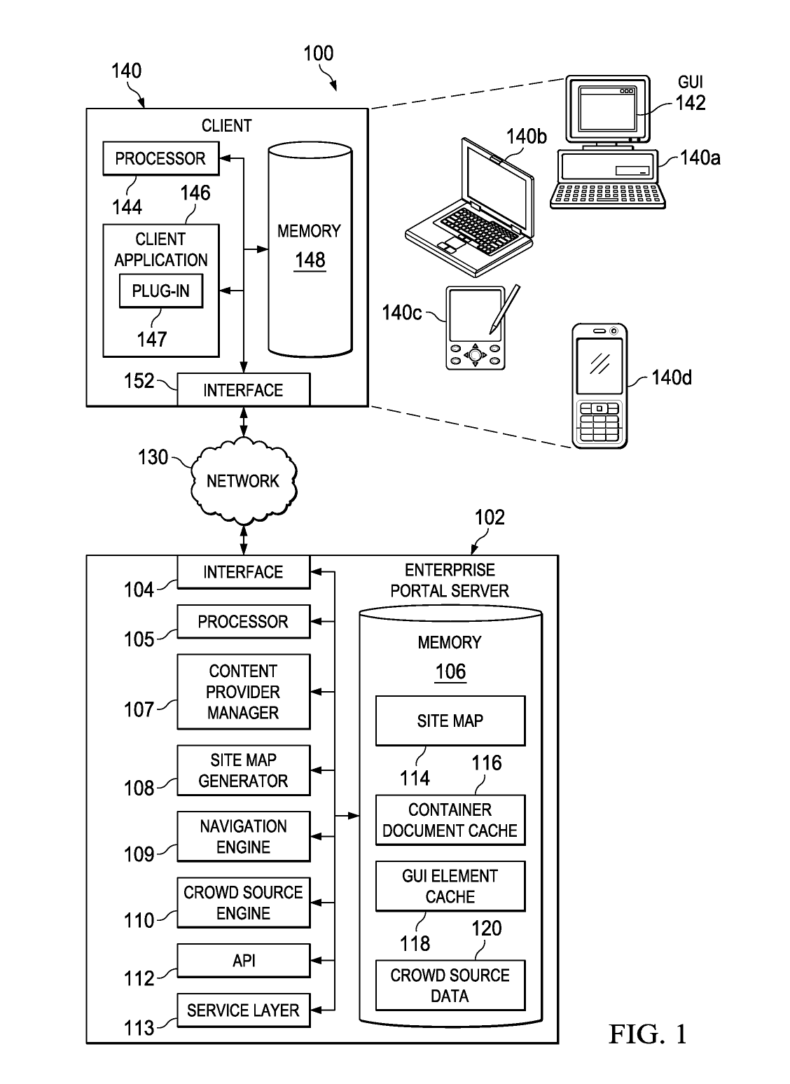

FIG. 1 is a block diagram illustrating an example distributed computing system 100 for providing assisted portal navigation and crowd-based feedback. The illustrated example distributed computing system 100 includes or is communicably coupled with an EP server (EPS) 102 and a client 140 (described below) that communicate across a network 130 (described below).

At a high level, the EPS server 102 is an electronic computing device operable to receive, transmit, process, store, or manage data and information associated with the example distributed computing system 100. Generally, the EPS server 102 allows users to navigate to, view, compose, modify, delete, and deploy EP container documents. Specifically, the described computer-implemented methods, software, and systems provide functionality for providing assisted portal navigation and crowd-based feedback through one or more graphical user interfaces (GUIs) providing a user with an efficient and user-friendly presentation of data provided by or communicated within the example distributed computing system 100.

The EPS 102 is responsible for receiving application requests, for example portal navigation and crowd-based feedback requests, from one or more client applications 146 (described below) associated with the client 140 of the example distributed computing system 100 and responding to the received requests by processing said requests in a content provider manager 107 (described below), and sending the appropriate response from the content provider manager 107 back to the requesting client application 146. In addition to requests from the client 140, requests associated with the content provider manager 107 may also be sent from internal users, external or third-party customers, other automated applications, as well as any other appropriate entities, individuals, systems, or computers. According to one implementation, EPS 102 may also include or be communicably coupled with an e-mail server, a web server, a caching server, a streaming data server, and/or other suitable server.

The EPS 102 contains a content provider manager 107, a site map generator 108, a navigation engine 109, and a crowd-source engine 110 where at least a portion of the content provider manager 107, the site map generator 108, the navigation engine 109, and/or the crowd-source engine 110 is executed using requests/responses sent from/to a client 140 within and communicably coupled to the illustrated example distributed computing system 100 using the network 130. In some implementations, requests/responses can be sent directly to EPS 102 from a user accessing EPS 102 directly. In some implementations, the EPS 102 may store a plurality of content provider managers 107, site map generators 108, navigation engines 109, and/or crowd-source engines 110. In some implementations, the EPS 102 may comprise a web server, where one or more of the components of EPS 102 represent web-based applications accessed and executed by the client 140 using the network 130 or directly at the EPS 102 to perform the programmed tasks or operations of the various components of EPS 102.

In some implementations, any and/or all of components of the EPS 102, both hardware and/or software, may interface with each other and/or the interface using an application programming interface (API) 112 and/or a service layer 113. The API 112 may include specifications for routines, data structures, and object classes. The API 112 may be either computer-language independent or dependent and refer to a complete interface, a single function, or even a set of APIs. The service layer 113 provides software services to the example distributed computing system 100. The functionality of the EPS 102 may be accessible for all service consumers using this service layer. Software services, such as those provided by the service layer 113, provide reusable, defined business functionalities through a defined interface. For example, the interface may be software written in JAVA, C++, or other suitable language providing data in extensible markup language (XML) format or other suitable format.

While illustrated as an integrated component of the EPS 102 in the example distributed computing system 100, alternative implementations may illustrate the API 112 and/or the service layer 113 as stand-alone components in relation to other components of the example distributed computing system 100. Moreover, any or all parts of the API 112 and/or the service layer 113 may be implemented as child or sub-modules of another software module, enterprise application, or hardware module without departing from the scope of this disclosure.

The EPS 102 includes an interface 104. Although illustrated as a single interface 104 in FIG. 1, two or more interfaces 104 may be used according to particular needs, desires, or particular implementations of the example distributed computing system 100. The interface 104 is used by the EPS 102 for communicating with other systems in a distributed environment—including within the example distributed computing system 100—connected to the network 130; for example, the client 140 as well as other systems communicably coupled to the network 130 (not illustrated). Generally, the interface 104 comprises logic encoded in software and/or hardware in a suitable combination and operable to communicate with the network 130. More specifically, the interface 104 may comprise software supporting one or more communication protocols associated with communications such that the network 130 or interface's hardware is operable to communicate physical signals within and outside of the illustrated example distributed computing system 100.

The EPS 102 includes a processor 105. Although illustrated as a single processor 105 in FIG. 1, two or more processors may be used according to particular needs, desires, or particular implementations of the example distributed computing system 100. Generally, the processor 105 executes instructions and manipulates data to perform the operations of the EPS 102. Specifically, the processor 105 executes the functionality required to provide assisted portal navigation and crowd-based feedback.

The EPS 102 also includes a memory 106 that holds data for the EPS 102. Although illustrated as a single memory 106 in FIG. 1, two or more memories may be used according to particular needs, desires, or particular implementations of the example distributed computing system 100. While memory 106 is illustrated as an integral component of the EPS 102, in alternative implementations, memory 106 can be external to the EPS 102 and/or the example distributed computing system 100. In some implementations, the memory 106 includes one or more instances of a site map 114, a container document cache 116, a GUI element cache 118, and crowd-source data 120.

The site map 114 is a list of container documents associated with a portal, for example portal pages, that are accessible to users and/or other computing systems and provides an overview of a portal's content. The site map 114 can be stored and/or represented in any form, for example a database table, flat file, binary file, or other suitable file and represents the relationships, typically hierarchical, between container documents that make up the portal. The site map 114 can be user visible to help a portal user find portal container documents and/or associated content. The site map can also be usable by a computing system, search engine, and the like to determine the number, relationship, and content of container documents associated with the portal and to present information to a portal user to help the portal user to navigate the container documents associated with the portal. In some implementations, the site map 114 need not contain every container document of a hierarchy of container documents available to the portal.

The container document cache 116 is a mechanism, data structure, memory, etc. used for the temporary storage (caching) of copies of container documents, such as portal pages, and associated container document content that pass through it. Cached content may include, among other things, text, images, audio, video, and animations. Later requests for a cached container document may be served from the container document cache 116 instead of the cached content's original source. In some implementations, the container document cache 116 can store associated reduced size images to be served in a preview capacity for a cached/not cached full-size container document. In some implementations, the container document cache 116 can partially or fully cache a container document(s) and can also pre-calculate or contain/refer-to pre-calculated content, active content hyperlinks, GUI elements, etc. that are associated with a particular portal container document in order to make navigation faster and more efficient.

Similarly, the GUI element cache 118 is a cache used to store an icon-like “GUI element” used to represent full-sized container documents. For example, a GUI element may be generated for each container document associated with the portal and stored in the GUI element cache 118. Appropriate GUI elements are then retrieved and rendered to represent full size container documents, for example in a matrix-like GUI display of GUI elements, where the full size container documents are associated with a hyperlink displayed on a container document. The site map 114 may also be used to determine which GUI elements should be displayed in relation to the hyperlink. In some implementations, the GUI element cache 118 can be incorporated into the container document cache 116. In some implementations, the GUI element cache 118 can also partially or fully cache a GUI element(s) and can also pre-calculate or contain/refer-to pre-calculated content, active content hyperlinks, GUI elements, etc. that are associated with a particular GUI element in order to make navigation faster and more efficient.

In some implementations, the content of a container document can be referenced by, for example, a “<key,value>” type of data structure within the container document cache 116 indicating data “values” associated with a unique “key” value associated with the container document. This will allow the cached content associated with a particular container document to be retrieved in an efficient manner to provide a fast and user-friendly navigation experience. In these implementations, the site map generator 108 can populate the “<key,value>” data to be ready for retrieval by the navigation engine 109.

The crowd-source data 120 is received retrieved, and/or aggregated data related to recommendations for reorganization/restructuring of portal container documents made by each of a distributed group of portal users. For example, a portal user may believe that it would be better to move a portal container document up multiple levels in the portal container document hierarchy. The crowd-source data 120 would reflect the portal user's recommendation. The crowd-source data 120 may be entered by various methods, including, for example, a textual description, data reflecting a drag-n-drop operation of a hyperlink on a GUI interface, changes made to a site map 114, or other suitable method as long as the crowd-source data 120 reflects a recommendation of a portal user to reorganize/restructure the portal container documents and provides details of the recommended portal container document reorganization/restructuring.

In some implementations, the crowd-source data 120 can contain metrics data used to aggregate statistics for each active content hyperlink/associated portal container document as well as preconfigured thresholds associated with the metrics data. For example, metrics data associated with each active content hyperlink may include a set of numbers, such as “<126,5,125>.” The first number indicates the number of unique users that have suggested a change in the portal container document's location in the portal container document hierarchy. The second number indicates the most often recommended portal container document hierarchy level recommended. The third number indicates a threshold associated with the first number over which a threshold alert is generated. In some implementations, multiple sets of numbers may be used to indicate all portal container document hierarchy levels suggested for a particular active content link/portal container document. For example, one implementation of metrics data could be “<43,1,350>;<23,2,250>;<16,3,225>;<6,4,175>;<126,5,125>;<114,6,115>” indicating hierarchy levels 1-6 (second number) and the number of unique users that have suggested that particular hierarchy level (first number). As will be appreciated by those of skill in the art, these example implementations are representative only and are not meant to be limiting in any way. The metrics data could be represented and/or store in a multitude of various ways consistent with this disclosure.

In some implementations, once a pre-configured threshold associated with the first and/or the second number has been passed, portal administration can be notified within a dedicated administrative environment (not illustrated) of the fact the threshold(s) have been exceeded. The dedicated administrative environment may be any suitable user interface environment and is used by portal administrative to at least manage crowd-source reorganization requests and related tasks. For example, with respect to “<126,5,125>,” a notification alert could be generated by the crowd-source engine 110 (described below) reflecting that “126” unique users have suggested a change to an associated active content link/portal container document to a hierarchy level of “5” and that the suggested reorganization should now be allowed. Based on the received notification alert(s), the portal administration can indicate within the dedicated administrative environment which active content hyperlink/portal container document reorganization requests should be allowed. Once the portal administrative approves a particular reorganization request, in some implementations, a message is sent from the crowd-source engine 110 to the site map generator 108 (described below) to trigger a reorganization of the portal container document hierarchy reflected in the site map 114. In some implementations, once the reorganization has been completed, the metrics data may be wholly or partially reset with respect to the associated active content link/portal container document.

In some implementations, the metrics data could also be used to count the number of unique visitors selecting a particular active content hyperlink/portal container document and can provide portal administration quantitative/statistical information about the active content link/portal container document that can be used by portal administration to, for example, decide whether to move the active content link to a different location in the portal container document hierarchy. The metrics data may also be used, based on the popularity of an active content hyperlink/portal container document, to make automatic adjustments to the location of the active content link/portal container document in the portal container document hierarchy. The metrics data can also be used to provide most recently browsed recommendations to portal users. For example, the portal can automatically provide a page with all recently visited/suggested active content hyperlinks/portal container documents. Other uses for the metrics data consistent with this disclosure are also envisioned.

The crowd-source data 120 can be stored and/or represented in any form, for example a database table, flat file, binary file, or other suitable file. In some implementations, the crowd-source data 120 can be organized to aggregate similar recommendations into groups for review by portal administration or provide data points allowing another application to perform the aggregation using the crowd-source data 120. In some implementations, the crowd-source data 120 may be extrapolated based on patterns or trends detected in the crowd-source data 120 at any particular point in time. In some implementations, the crowd-source data 120 can be modified by portal administration to reflect changes made to a portal based on the crowd-source data 120 or the rejection of a recommended portal container document reorganization/restructuring. The crowd-source data 120 may also be used to store historical information regarding recommended, preformed, and/or rejected portal container document reorganization/restructuring.

The content provider manager 107 is any type of application that allows the client 140 to request and view content on the client 140 after obtaining content from the EPS 102 and/or a content provider (not illustrated) in response to a received request from the client 140. A content provider may be, for example, applications and data on the EPS 102 and/or external services, business applications, business application servers, databases, RSS feeds, document servers, web servers, streaming servers, caching servers, or other suitable content sources. In some implementations, the content provider manager 107 enables the consumption of content provider content by client 140. In some implementations, the content provider manager 107 allows connections to various content providers, queries the content provider with regards to provided content, and enables a user to view, add, edit, and/or delete content associated with the EPS 102.

In some implementations, the content provider manager 107 can use content provider manager data (not illustrated) or other above-describe data stored in memory 106, for example the site map 114 and/or data from the container document cache 116/GUI element cache 118, to perform tasks associated with the EPS 102 or other components of the example distributed computing system 100. Content provider manager data may include any type of data associated with and/or used by the content provider manager 107, including content provider locations, addresses, storage specifications, content lists, access requirements, or other suitable data. For example, for a database content provider, the content provider manager data may include the server Internet Protocol (IP) address, URL, access permission requirements, data download speed specifications, etc.

Once a particular content provider manager 107 is launched, a client 140 may interactively process a task, event, or other information associated with the EPS 102. The content provider manager 107 can be any application, program, module, process, or other software that may execute, change, delete, generate, or otherwise manage information associated with a particular client 140, and in some cases, a business process (not illustrated) performing and executing business process-related events on the EPS 102 and/or the client 140. For example, the content provider manager 107 may be a portal application, a business application, and/or other suitable application consistent with this disclosure. Additionally, a particular content provider manager 107 may operate in response to and in connection with at least one request received from other content provider managers 107, including a content provider manager 107 associated with another EPS 102. In some implementations, the content provider manager 107 can be and/or include a web browser. In some implementations, each content provider manager 107 can represent a network-based application accessed and executed using the network 130 (e.g., through the Internet, or using at least one cloud-based service associated with the content provider manager 107). For example, a portion of a particular content provider manager 107 may be a web service associated with the content provider manager 107 that is remotely called, while another portion of the content provider manager 107 may be an interface object or agent bundled for processing at a remote client 140. Moreover, any or all of a particular content provider manager 107 may be a child or sub-module of another software module or enterprise application (not illustrated) without departing from the scope of this disclosure. Still further, portions of the particular content provider manager 107 may be executed or accessed by a user working directly at the EPS 102, as well as remotely at a corresponding client 140. In some implementations, the EPS 102 can execute the content provider manager 107.

The site map generator 108 can be any application, program, module, process, or other software to analyze a hierarchy of container documents and generate/re-generate a site map 114. In some implementations, analysis of a container document hierarchy by the site map generator 108 may include traversing the hierarchy by processing a base-level container document to analyze all paths, such as hyperlinks, URLs, etc. to additional container documents associated with the base-level container document. In some implementations, the additional container documents are at a lower hierarchical level than the base-level container document, which in other implementations, additional container documents can be at a higher and/or lower hierarchical level than the base-level container document. To traverse the container document hierarchy, the site map generator 108 may be or use a “crawler,” “spider,” “bot,” and/or other traversal application to crawl (traverse) paths of the container document hierarchy. In some implementations, the processing performed to generate the site map 114 can be recursive and/or any other suitable open source and/or proprietary method used to generate the site map 114. In some implementations, the site map generator 108 can detect, report, and/or repair problems discovered with the container document hierarchy and/or the site map 114. In some implementations, the site map generator 108 can determine titles associated with various GUI elements. In some implementations, the site map generator 108 can respond to a request, message, alert, etc. from portal administration and/or a component of the example distributed computing system 100 to restructure the site map 114. For example, if a metrics data threshold (described above) is exceeded, the site map generator 108 can be authorized/notified to perform a restructuring of the portal container document hierarchy reflected in the site map 114 to be consistent with the suggested reorganization as reflected in the metrics data.

A particular site map generator 108 may operate in response to and in connection with at least one request received from other site map generators 108, including a site map generator 108 associated with another EPS 102. In some implementations, the site map generator 108 can include a web browser. In some implementations, each site map generator 108 can represent a network-based application accessed and executed using the network 130 (e.g., through the Internet, or using at least one cloud-based service associated with the site map generator 108). For example, a portion of a particular site map generator 108 may be a web service associated with the site map generator 108 that is remotely called, while another portion of the site map generator 108 may be an interface object or agent bundled for processing at a remote client 140. Moreover, any or all of a particular site map generator 108 may be a child or sub-module of another software module or enterprise application (not illustrated) without departing from the scope of this disclosure. Still further, all or portions of the particular site map generator 108 may be executed or accessed by a user working directly at the EPS 102, as well as remotely at a corresponding client 140.

The navigation engine 109 can be any application, program, module, process, or other software to provide assisted portal navigation and crowd-based feedback. With respect to assisted portal navigation, the navigation engine 109 interfaces with site map 114 in order to provide various container documents and/or associated data to client 140 at the initialization of the client application 146/plug-in 147 (described below) and/or responsive to one or more requests received from the client application 146/plug-in 147. In some implementations, the navigation engine 109 also interfaces with the container document cache 116 and/or the GUI element cache 118 to retrieve, generate, update, and/or delete container documents/container document hierarchy associations and/or GUI elements, respectively. In some implementations, the navigation engine 109 detects and manages hover events. In some implementations, the navigation engine 109 can receive and/or generate events to replace content within a pop-up container document responsive to the selection of a graphical user element associated with the pop-up container document. For example, a pop-up container document may contain a “back” or “forward” arrow-type GUI element that when selected will replace the pop-up container document content at a particular container document hierarchy level, with content from a prior or later instance of a similar pop-up container document at another container document hierarchy level without having to navigate to the prior/later pop-up container document. In some implementations, the navigation engine 109 can determine titles associated with various GUI elements.

With respect to crowd-based feedback, the navigation engine 109 provides functionality to allow the client application 146/plug-in 147 to indicate a desire to reorganize/restructure the container document hierarchy. For example, in some implementations, a user can drag-and-drop a hyperlink/GUI element from a container document to another container document to indicate a recommendation that the hyperlink/container document represented by the GUI element should be moved to a different level of the container document hierarchy. Another possible indication method could include a right-click operation on a selected hyperlink/GUI element to expose a context menu with various options and/or suggestions on where to relocate the hyperlink/container document represented by the GUI element. In some implementations, the suggestions can be calculated dynamically by the navigation engine 109 and/or the crowd-source engine 110 (described below) based upon prior navigations and/or container documents generated because of detected events, such as hover events, related to hyperlinks or other GUI elements. Those of skill in the art will appreciate that these provided examples are exemplary only and that a myriad of other suitable methods exist to indicate a recommendation to reorganize/restructure the container document hierarchy, including text entry, use of pull-down menus, radio boxes, graphical hierarchy managers, and the like. Any provided examples are not meant to be limiting. In some implementations, the navigation engine 109 can trigger the site map generator 108 to reprocess the container document hierarchy and/or generate a new site map for the container document hierarchy.

A particular navigation engine 109 may operate in response to and in connection with at least one request received from other navigation engines 109, including a navigation engine 109 associated with another EPS 102. In some implementations, the navigation engine 109 can include a web browser. In some implementations, each navigation engine 109 can represent a network-based application accessed and executed using the network 130 (e.g., through the Internet, or using at least one cloud-based service associated with the navigation engine 109). For example, a portion of a particular navigation engine 109 may be a web service associated with the navigation engine 109 that is remotely called, while another portion of the navigation engine 109 may be an interface object or agent bundled for processing at a remote client 140. Moreover, any or all of a particular navigation engine 109 may be a child or sub-module of another software module or enterprise application (not illustrated) without departing from the scope of this disclosure. Still further, all or portions of the particular navigation engine 109 may be executed or accessed by a user working directly at the EPS 102, as well as remotely at a corresponding client 140.

The crowd-source engine 110 can be any application, program, module, process, or other software that may manage entry of portal user recommendations for a container document hierarchy reorganization/restructuring, administrative functions for portal administrators to view, approve, and/or reject active content hyperlink/portal container document reorganization requests through a dedicated administrative environment (described above), and/or managing reorganization/restructuring of the container document hierarchy following portal administrator approval or one or more portal user recommendations for reorganization/restructuring of the container document hierarchy. For example, in some implementations, the crowd-source engine 110 can interface with the content provider manager 107, navigation engine 109, and/or site map generator 108 to provide GUI functionality and information to convey to portal administration a recommendation to reorganize/restructure the container document hierarchy. The crowd-source engine 110 or other suitable component may provide portal administration a GUI as part of a dedicated administrative environment for viewing, approving, and/or rejecting recommendations to reorganize/restructure the container document hierarchy. In some implementations, the crowd-source engine 110 interfaces with the navigation engine 109 and may partially or wholly perform operations related to crowd-based feedback described above in relation to the navigation engine 109. In some implementations, the crowd-source engine 110 can trigger the site map generator 108 to reprocess the container document hierarchy and/or generate a new site map for the container document hierarchy.

A particular crowd-source engine 110 may operate in response to and in connection with at least one request received from other crowd-source engines 110, including a crowd-source engine 110 associated with another EPS 102. In some implementations, the crowd-source engine 110 can include a web browser. In some implementations, each crowd-source engine 110 can represent a network-based application accessed and executed using the network 130 (e.g., through the Internet, or using at least one cloud-based service associated with the crowd-source engine 110). For example, a portion of a particular crowd-source engine 110 may be a web service associated with the crowd-source engine 110 that is remotely called, while another portion of the crowd-source engine 110 may be an interface object or agent bundled for processing at a remote client 140. Moreover, any or all of a particular crowd-source engine 110 may be a child or sub-module of another software module or enterprise application (not illustrated) without departing from the scope of this disclosure. Still further, all or portions of the particular navigation engine 109 may be executed or accessed by a user working directly at the EPS 102, as well as remotely at a corresponding client 140.

In some implementations, the components of the example distributed computing environment 100 can also support one or more clustering environments. For example, the crowd-source engine 110 can synchronize a new portal container document generated by the site map generator 108 to multiple cluster nodes to consistently reflect a content reorganization to a clustering environment and users of the clustering environment.

The client 140 may be any computing device operable to connect to or communicate with at least the EPS 102 using the network 130. In general, the client 140 comprises an electronic computing device operable to receive, transmit, process, and store any appropriate data associated with the example distributed computing system 100. The client includes a processor 144, a client application 146, a plug-in 147, a memory 148, and/or an interface 148.

The client application 146 is any type of application that allows the client 140 to navigate to/from, request, view, edit, delete, and or manipulate content on the client 140. In some implementations, the client application 146 can be and/or include a web browser. In some implementations, the client-application 146 can use parameters, metadata, and other information received at launch to access a particular set of data from the EPS 102. Once a particular client application 146 is launched, a user may interactively process a task, event, or other information associated with the EPS 102. Further, although illustrated as a single client application 146, the client application 146 may be implemented as multiple client applications in the client 140. In some implementations, the client application 146 may act as a GUI interface for the content provider manager 107 and/or other components of EPS 102 and/or other components of the example distributed computing environment 100.

The plug-in 147 can be any application, program, module, process, or other software that interfaces with the client application 146 to provide functionality for assisted portal navigation and/or crowd-based feedback. In some implementations, the plug-in 147 provides enhanced/non-native functionality to the client application 146, for example if the client application 146 is a web browser. In some implementations, the plug-in 147 can be provided by the EPS 102 owner and/or a third-party. Enhanced/non-native functionality may include the ability to drag-and-drop various GUI components from one GUI to another, enter textual or other data, navigate back and forth between various GUI states, “pin” various GUIs to a desktop for later reference, and the like. Although the plug-in 147 is illustrated in FIG. 1 as integral to the client application 146, in some implementations, the plug-in 147 can be a stand-alone component interfacing with the client application 146.

The interface 152 is used by the client 140 for communicating with other computing systems in a distributed computing system environment, including within the example distributed computing system 100, using network 130. For example, the client 140 uses the interface to communicate with the EPS 102 as well as other systems (not illustrated) that are communicably coupled to the network 130. The interface 152 may be consistent with the above-described interface 104 of the EPS 102 or other interfaces within the example distributed computing system 100. The processor 144 may be consistent with the above-described processor 105 of the EPS 102 or other processors within the example distributed computing system 100. Specifically, the processor 144 executes instructions and manipulates data to perform the operations of the client 140, including the functionality required to send requests to the EPS 102 and to receive and process responses from the EPS 102. The memory 148 may be consistent with the above-described memory 106 of the EPS 102 or other memories within the example distributed computing system 100 but storing objects and/or data associated with the purposes of the client 140, including site maps, cached data, container documents, GUI elements, and crowd-source information similar to that stored in memory 106 of EPS 102. In some implementations, the memory 148 may be used by EPS 102 to store objects and/or data.

Further, the illustrated client 140 includes a GUI 142. The GUI 142 interfaces with at least a portion of the example distributed computing system 100 for any suitable purpose, including generating a visual representation of a web browser. The GUI 142 may be used to view and navigate various web pages located both internally and externally to the EPS 102. In particular, the GUI 142 may be used to perform functions for providing assisted portal navigation and crowd-based feedback consistent with this disclosure.

There may be any number of clients 140 associated with, or external to, the example distributed computing system 100. For example, while the illustrated example distributed computing system 100 includes one client 140 communicably coupled to the EPS 102 using network 130, alternative implementations of the example distributed computing system 100 may include any number of clients 140 suitable to the purposes of the example distributed computing system 100. Additionally, there may also be one or more additional clients 140 external to the illustrated portion of the example distributed computing system 100 that are capable of interacting with the example distributed computing system 100 using the network 130. Further, the term “client” and “user” may be used interchangeably as appropriate without departing from the scope of this disclosure. Moreover, while the client 140 is described in terms of being used by a single user, this disclosure contemplates that many users may use one computer, or that one user may use multiple computers.

The illustrated client 140 is intended to encompass any computing device such as a desktop computer, laptop/notebook computer, wireless data port, smart phone, personal data assistant (PDA), tablet computing device, one or more processors within these devices, or any other suitable processing device. For example, the client 140 may comprise a computer that includes an input device, such as a keypad, touch screen, or other device that can accept user information, and an output device that conveys information associated with the operation of the EPS 102 or the client 140 itself, including digital data, visual and/or audio information, or a GUI 142, as shown with respect to the client 140.

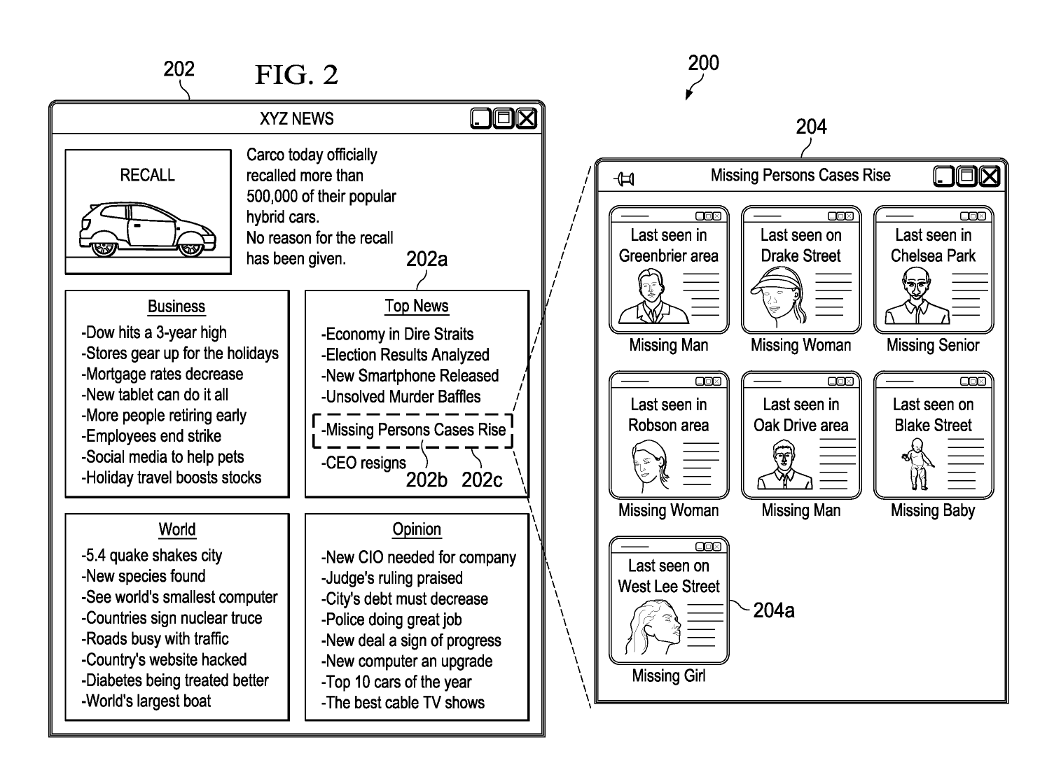

FIG. 2 is a block diagram 200 illustrating a base-level container document 202 and an associated first-level pop-up container document 204. The base-level container document 202 could be, for example, a news website home page for “XYZ News.” The home page is made up of different sections, including “Top News” 202a. Section 202a contains a number of active content hyperlinks, including “Missing Person Cases Rise” 202b.

If a portal user hovers over hyperlink 202b, for example with a mouse pointer or other similar pointing indicator, a hover event associated with hyperlink 202b is detected by the EPS 102 and a first-level pop-up container document 204 is displayed. In some implementations, hovering over a hyperlink generates a hover indicator associated with the hyperlink. FIG. 2 illustrates one possible hover indicator, a dashed box 202c, but this is only exemplary and not meant to be limiting. As will be appreciated those skilled in the art, many other possible methods of indicating a hover action associated with a GUI element exist.

Container document 204 contains one or more GUI elements, for example, GUI element 204a “Missing Girl.” Each GUI element in container document 204 represents a container document accessible using hyperlink 202b. In some implementations, the container document 204 containing the one or more GUI elements can arrange the one or more GUI elements in a matrix-type pattern. In other implementations, the GUI elements can be arranged in any other suitable pattern. In some implementations, a short title is associated with each GUI element to help the portal user understand what the GUI elements represent. If the portal user selects a GUI element, for example by left-clicking a mouse or with some other suitable selection method, the full container document represented by the GUI element is displayed in a web browser or other web-browsing capable application.

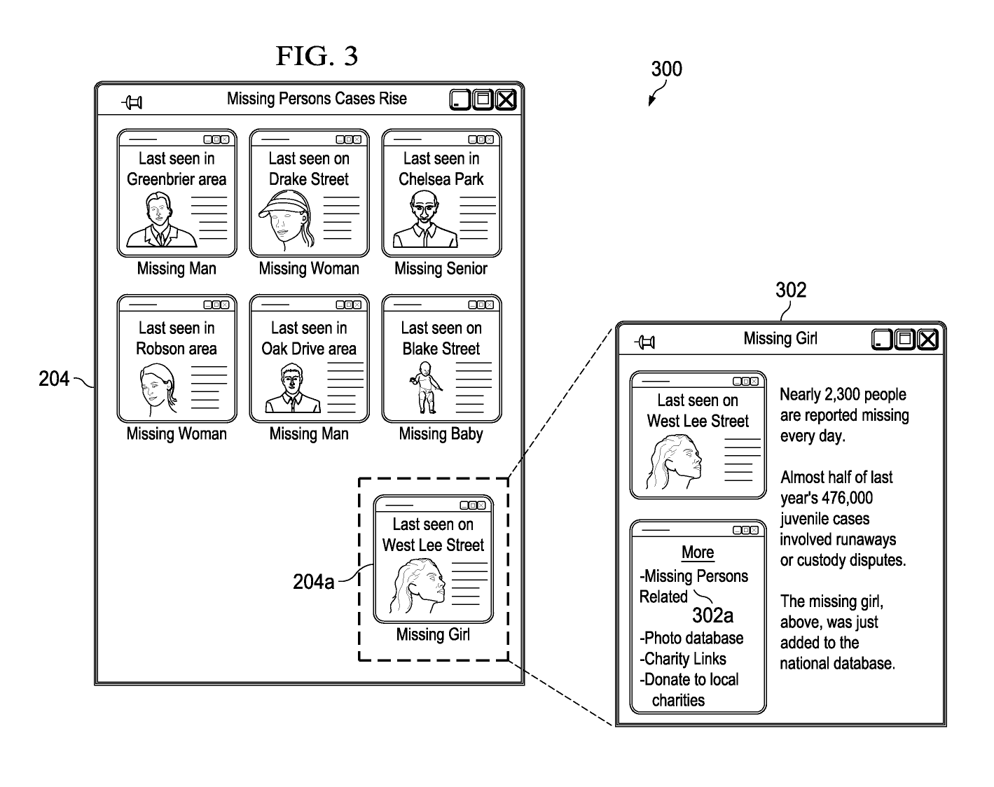

FIG. 3 is a block diagram 300 illustrating the first-level pop-up container document 204 and an associated first-level detailed pop-up container document 302. If the portal user hovers over a GUI element, for example GUI element 204a, a hover event associated with GUI element 204a is detected by the EPS 102 and a first-level detailed pop-up container document 302 is displayed. As with hovering over a hyperlink, hovering over a GUI element can generate a hover indicator (here illustrated the same as with hyperlink 202b in FIG. 2) associated with the GUI element.

Detailed pop-up container document 302 is a miniaturized representation of the full-size container document represented by the GUI element 204a. The miniaturized representation is to allow the portal user to get a representative view of the container document represented by the GUI element 204a. In some implementations, one or more hyperlinks associated with container document 302 remain active, for example “Missing Persons Related” 302a in the “More” section. In some implementations, some content associated with the full-sized container document represented by GUI element 204 may be rendered inactive before being displayed in container document 302, while in other implementations, all content remains active. In some implementations, if the portal user selects the title and/or non-active content of the container document 302, the full-size container document is displayed in a web browser or other web-browsing capable application.

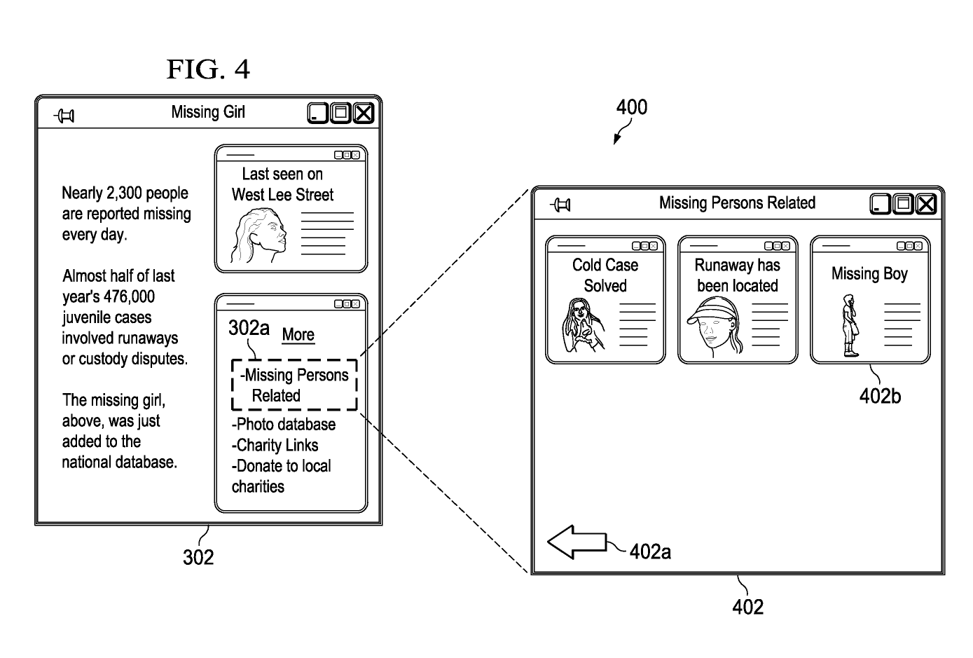

FIG. 4 is a block diagram 400 illustrating the first-level detailed pop-up container document 302 and a second-level pop-up container document 402. The first-level detailed pop-up container document 302 here represents a full-size container document and contains active content hyperlinks, for example hyperlink 302a “Missing Persons Related.” If a portal user hovers over hyperlink 302a, a hover event associated with hyperlink 302a is detected by the EPS 102 and a second-level pop-up container document 402 is displayed. Container document 402 contains one or more GUI elements, for example, GUI element 204a “Missing Girl.” Each GUI element in container document 402 represents a container document accessible using hyperlink 302a.

In some implementations, the navigation engine can generate GUI elements associated with pop-up container document navigation. For example, a pop-up container document may contain “back” or “forward” arrow-type GUI element generated by the navigation engine following navigation into “lower” hierarchical levels of portal container documents. Once a user has navigated to say a lower level container document, the selection of an available arrow will replace the content in that container document with prior/later content associated with a prior/later level container document of the same type without having to navigate to the prior/later container document. Note that container document 402 contains a GUI left arrow 402a. There is no “right” GUI arrow because there is no lower level or similar container document “after” container document 402 that has been navigated to. If a portal user selected left arrow 402a, in some implementations, the content from the first-level pop-up container document 204 would be displayed within the second-level pop-up container document 402 along with a new “forward” type arrow indicating that content is also available at a lower hierarchical level, here the contents of the second-level pop-up container document 402. Note that while container document 204 did not originally have a right GUI arrow, it would be rendered in the container document due to the existence of a later similar container document 402.

In some implementations, the GUI elements also permit a portal user to make a crowd-source recommendation as to where a container document should exist in the container document hierarchy. For example, in one implementation, if the user selects and drags GUI element 402b to “touch” GUI arrow 402a, the contents of container document 402 would change to reflect the content of similar container document 204 (displaying GUI elements) to allow the portal user to drop the GUI element into container document 204. In some implementations, once the drop operation is complete, the contents of the container document would revert to the contents of container document 402 minus the GUI element dragged from container document 402 to container document 204. In some implementations, only one container document similar to container document 402 is displayed on the screen and is reused as the portal user navigates through the hierarchy of container documents. In other implementations, more than one container document similar to pop-up container documents 204 and 402 are capable of being displayed at the same time.

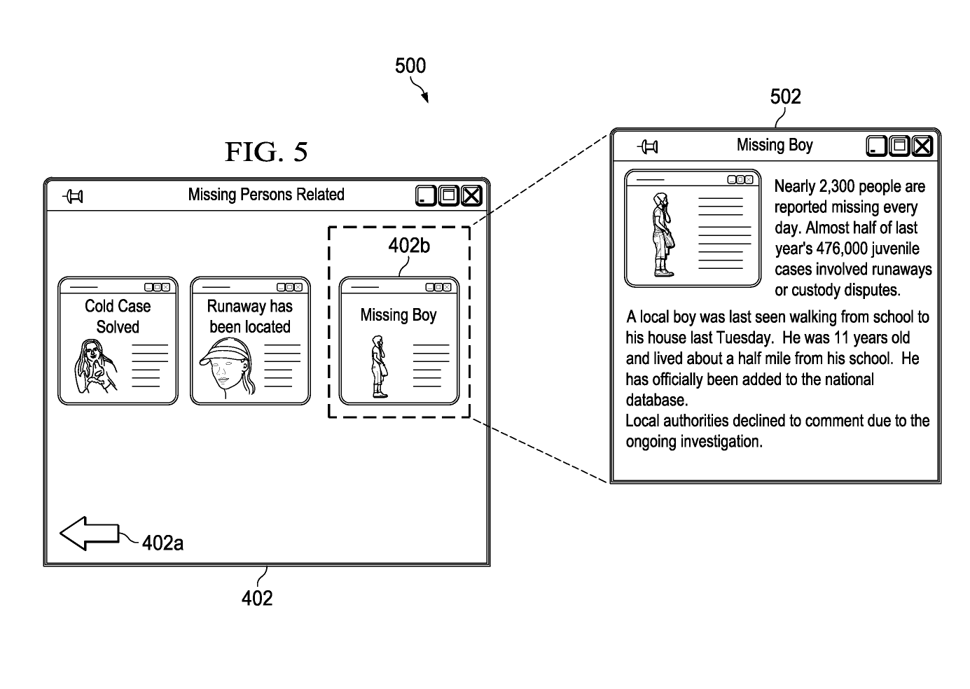

FIG. 5 is a block diagram 500 illustrating the second-level pop-up container document 402 and an associated second-level detailed pop-up container document 502. Refer to FIG. 3 for operational details.

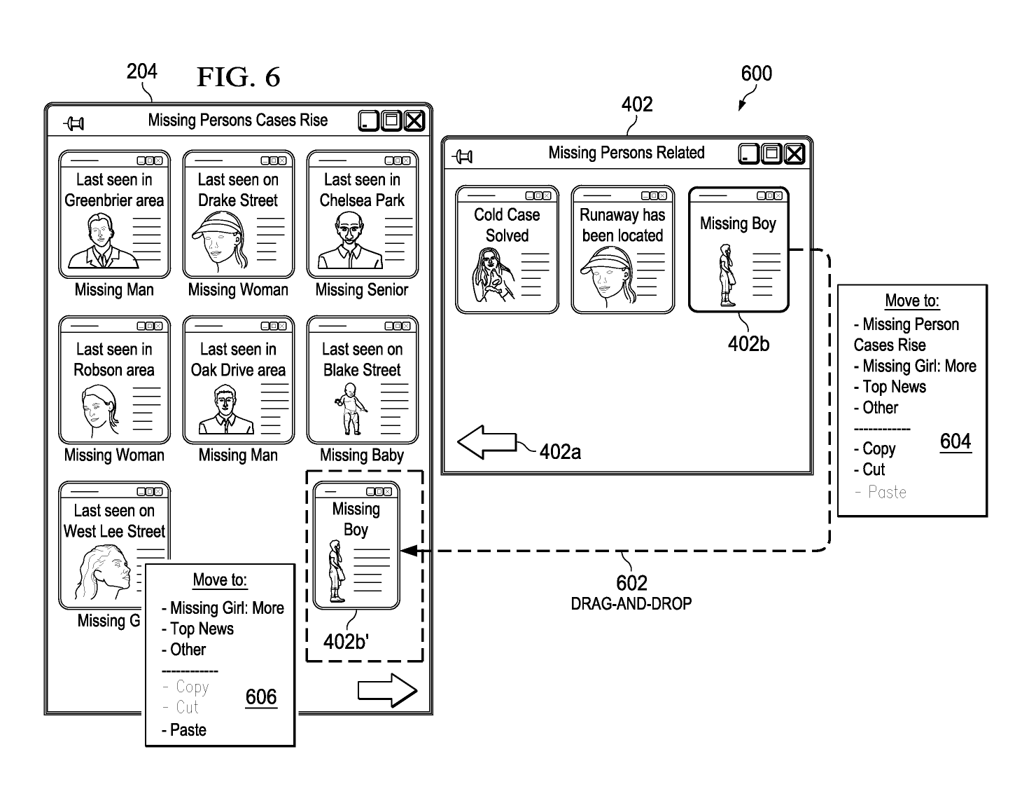

FIG. 6 is a block diagram 600 illustrating the first-level pop-up container document 204 and the second-level pop-up container document 402 used in a crowd-based feedback operation to recommend relocating container documents within the container document hierarchy. A portal user can make crowd-based feedback recommendations for reorganizing/restructuring the container document hierarchy by indicating a desire to relocate a container document within the container document hierarchy. For example, the portal user may select GUI element 402b, such as by clicking with at mouse or other pointing device and then performing a drag-and-drop operation 602 to container document 204. The GUI element 402b is then placed into container document 204 as 402b′. In some implementations, the GUI element 402b′ will remain in a temporary status with a particular look and feel under a portal administrator makes a decision as to whether the relocation recommendation is to be allowed. In some implementations, local client-based copies of necessary caches, such as the container document cache 116 and the GUI element cache 118 along with a local copy of the site map 114 are updated to reflect a temporary but functional move of GUI element 402b for the particular portal user. In these implementations, other portal users may or may not have access to container documents as reflected by the recommended relocation. In other implementations, other users would see a graphical indication (not illustrated) of the recommendation and would be allowed by either the navigation engine 109 and/or the crowd-source engine 110 to make comments regarding the recommended change to the portal administrators. Particular GUI interfaces (not illustrated) could also be provided to allow other portal users to provide comments to the portal administrators. In the case that the recommended change is approved by the portal administrators, the changed container document hierarchy is reprocessed and an updated site map is generated, thus reflecting the change to other portal users.

In addition to a drag-and-drop type operations, in some implementations, a portal user can right-click on a GUI element and be presented a context menu with various functions. For example, context menu 604 may recommend possible container document hierarchy locations to move the full container document represented by GUI element 402b. Note that in some implementations, “Move to:” recommendations depend upon which container document the GUI element is associated with. Further, the context menus 604/606 allow the portal user to perform copy- or cut-and paste type operations. For example, context menu 604 would allow the portal user to “copy” or “cut” selected GUI element 402b from container document 402 and “paste” it into container document 204 using context menu 606. Other methods of indicating a desire to reorganize/restructure the container document hierarchy consistent with this disclosure are envisioned. The exemplary provided examples are in no way intended to limit this functionality to the provided examples.

In some implementations, once a recommended change has been approved by portal administration, a reorganized active content hyperlink/GUI element can be modified in a manner to indicate the reorganization. For example, the active content hyperlink/GUI element could be marked for a certain amount of time with a special sign, label, logo, color, etc. to indicate it has been relocated to the new location. Similarly, the active content hyperlink/GUI element could be marked in the old location to indicate it will be removed from that location after a certain amount of time. This marking permits portal users to further comment to portal administration that the allowed reorganization was a mistake, etc. or to even perform operations to recommend a further reorganization of the active content hyperlink/GUI element.

In some implementations, while suggestions as to content reorganization are typically made by portal users, factors such as the portal container document hierarchy page structure, available space, location within a container document, navigation practicality, and other suitable factors can be analyzed/weighed as to whether to approve a reorganization request. In these implementations, the analysis/weighing can be performed by one or more of the content provider manager 107, the site map generator 108, the navigation engine 109, the crowd-source engine 110, or other suitable component (illustrated or not) of the example distributed computing environment 100.

While the provided examples illustrate the relocating of GUI elements, this functionality is envisioned as also being operable on hyperlinks in a manner consistent with this disclosure. For example, hyperlink 302a could be dragged-and-dropped, copy- or cut-and-pasted, etc. from container document 302 to container document 204. In this case, a GUI element(s) would be displayed for the relocated hyperlink (depending upon how many container documents are associated with the hyperlink), possibly with a temporary look and feel, the hyperlink would be removed from container document 302, and a crowd-based relocation recommendation would be sent to the navigation engine 109 and/or the crowd-source engine 110 for review by the portal administrators. Hyperlink 302a could also be selected and “held” for a certain amount of time using a display pointer or with a touchscreen interface. In this instance, the hyperlink 302a could then be indicated as ready to be dragged-and-dropped, such as by changing color to gray and causing the hyperlink 302a to “shake” on the screen.

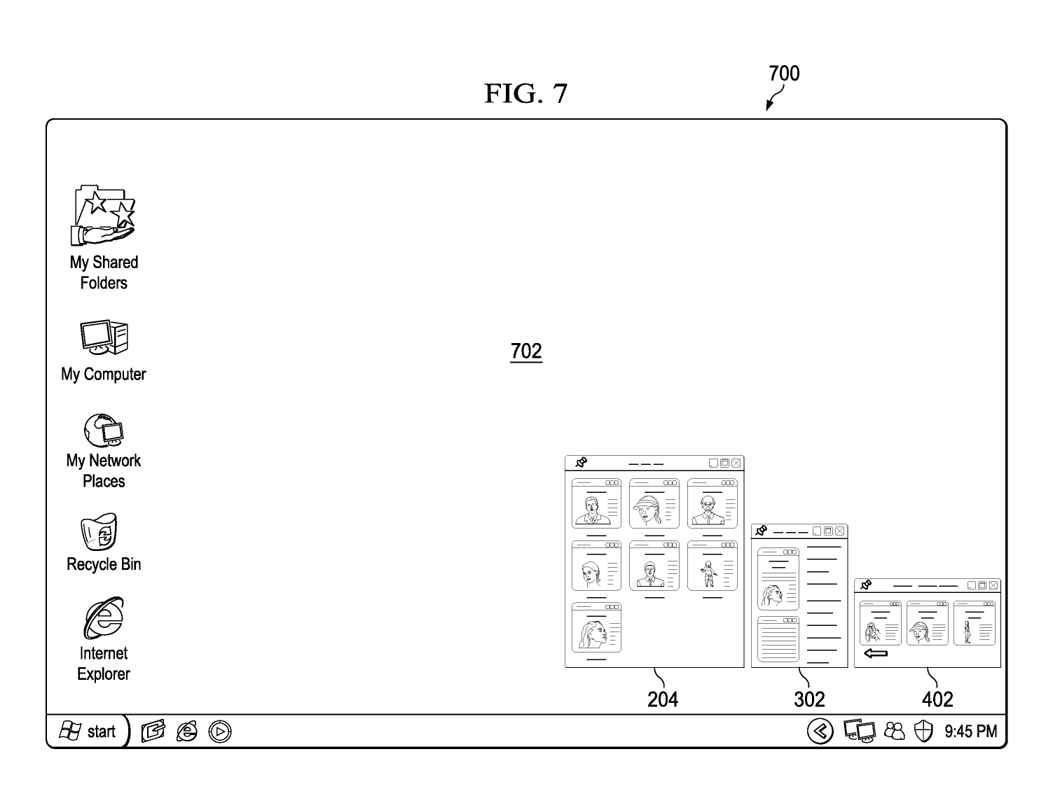

FIG. 7 is a block diagram 700 illustrating container documents 240, 302, and 402 “pinned” to a desktop. The container documents are pinned in place for portal user convenience. In some implementations, if container documents associated within the container document hierarchy as reflected by the pinned container documents are added, modified, removed, etc. the pinned container document is updated synchronously and/or asynchronously to reflect the change to the container document hierarchy. For example, if a container document is added/removed from the container document hierarchy level reflected by container document 204, container document 204 would update to reflect the addition/removal by the addition/removal of a GUI element. In another example, if content related to container document 302 is updated in the container document hierarchy, the displayed content would be updated within container document 302.

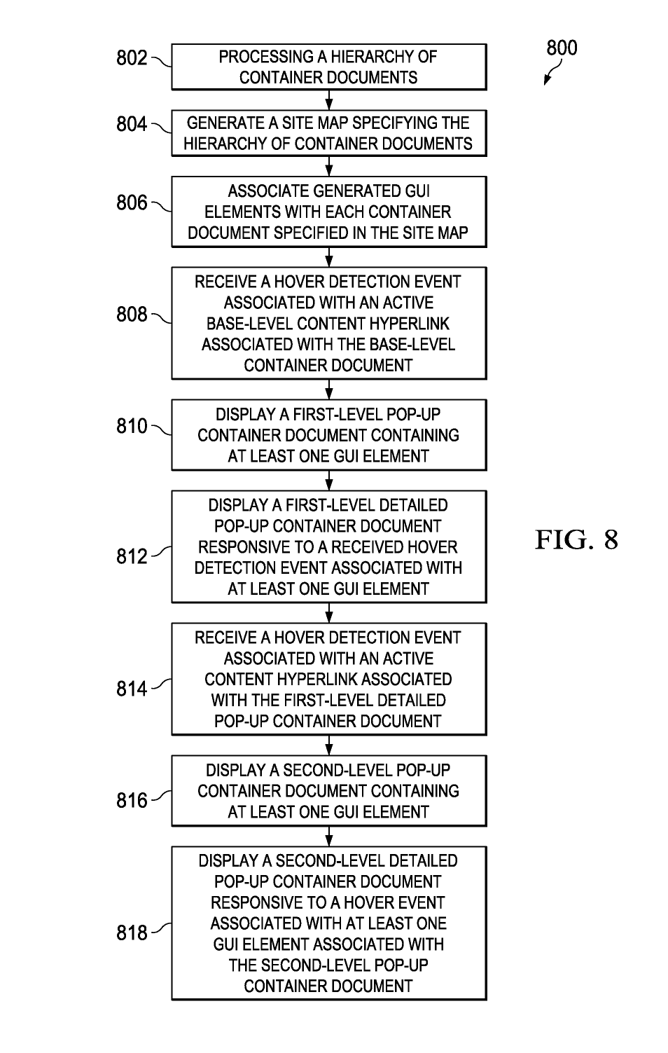

FIG. 8 is a flow chart illustrating a method 800 for assisted portal navigation. For clarity of presentation, the description that follows generally describes method 800 in the context of FIGS. 1-7. However, it will be understood that method 800 may be performed, for example, by any other suitable system, environment, software, and hardware, or a combination of systems, environments, software, and hardware as appropriate.

At 802, a hierarchy of container documents is processed. The processing may begin at any hierarchy level and determines the hierarchical structure of the container documents. From 802, method 800 proceeds to 804.

At 804, a site map is generated that specifies the determined hierarchy of the container documents. In some implementations, some container documents in the determined hierarchy can be excluded from the generated site map. From 804, method 800 proceeds to 806.

At 806, a GUI element is generated and associated with each container document specified in the site map. In some implementations, GUI elements are generated and stored in the GUI element cache for each container document in the container document hierarchy, regardless of whether specified in the site map. From 806, method 800 proceeds to 808.

At 808, a hover detection event associated with an active base-level container document content hyperlink is received. From 808, method 800 proceeds to 810.

At 810, a first-level pop-up container document is displayed, where the first-level pop-up container document contains at least one GUI element representing a container document associated with the active base-level content hyperlink of 808. From 810, method 800 proceeds to 812.

At 812, responsive to a received hover detection event associated with the at least one GUI element displayed in the first-level pop-up container document, a first-level detailed pop-up container document is displayed. The first-level detailed pop-up container document presents a miniaturized version of the full-size container document represented by the at least one GUI element of 810. From 812, method 800 proceeds to 814.

At 814, a hover detection event associated with an active content hyperlink associated with the first-level detailed pop-up container document of 812 is received. From 814, method 800 proceeds to 816.

At 816, a second-level pop-up container document is displayed, where the second-level pop-up container document contains at least one GUI element representing a container document associated with the active base-level content hyperlink of 814. From 816, method 800 proceeds to 818.

At 818, responsive to a received hover detection event associated with the at least one GUI element displayed in the second-level pop-up container document, a second-level detailed pop-up container document is displayed. The second-level detailed pop-up container document presents a miniaturized version of the full-size container document represented by the at least one GUI element of 816. From 818, method 800 stops.

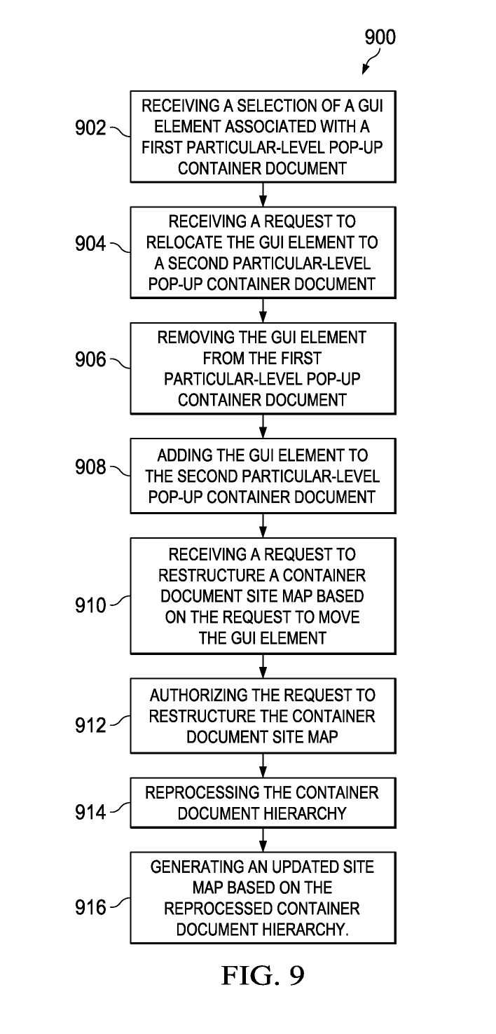

FIG. 9 is a flow chart illustrating a method 900 for providing crowd-based feedback during assisted portal navigation. For clarity of presentation, the description that follows generally describes method 900 in the context of FIGS. 1-8. However, it will be understood that method 900 may be performed, for example, by any other suitable system, environment, software, and hardware, or a combination of systems, environments, software, and hardware as appropriate. Although method 900 discusses selection and a crowd-based recommendation of a relocation of the container document represented by the GUI element within the hierarchy of container documents, the method is also envisioned, consistent with this disclosure, to also encompass the selection and recommended relocation of content hyperlinks and all associated container documents within the container document hierarchy.

At 902, a selection of a particular GUI element associated with a first particular-level pop-up container document is received. From 902, method 900 proceeds to 904.

At 904, a request is received to relocate the particular GUI element of 902 to a second particular-level pop-up container document. From 904, method 900 proceeds to 906.

At 906, the GUI element is removed from the first particular-level pop-up container document. In some implementations, the GUI element is left in place and may be indicated in some manner to have been recommended as moved. In these implementations, the GUI element may or may not be active to the portal user. From 906, method 900 proceeds to 908.

At 908, The GUI element is added to the second particular-level pop-up container document. In some implementations, the GUI element is indicated as being in a temporary status and may or may not be active to the portal user until a decision on the relocation recommendation is made by the portal administrators. From 908, method 900 proceeds to 910.

At 910, a crowd-based relocation recommendation to restructure a container document site map is received based upon the received request at 904. From 910, method 900 proceeds to 912.

At 912, the portal administrators authorize the crowd-based relocation recommendation of 910. In some implementations, some subset of portal users may act as portal administrators to authorize the crowd-based relocation recommendation. From 912, method 900 proceeds to 914.

At 914, the container document hierarchy reprocessed. The processing may begin at any hierarchy level and determines the hierarchical structure of the updated container document hierarchy due to 912. From 912, method 900 proceeds to 914.

At 916, an updated site map is generated based upon the reprocessed container document hierarchy. From 916, method 900 stops.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible, non-transitory computer-storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example LINUX, UNIX, WINDOWS, MAC OS, ANDROID, IOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a CPU, a FPGA, or an ASIC.

Computers suitable for the execution of a computer program include, by way of example, can be based on general or special purpose microprocessors or both, or any other kind of CPU. Generally, a CPU will receive instructions and data from a read-only memory (ROM) or a random access memory (RAM) or both. The essential elements of a computer are a CPU for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a global positioning system (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., erasable programmable read-only memory (EPROM), electrically-erasable programmable read-only memory (EEPROM), and flash memory devices; magnetic disks, e.g., internal hard disks or removable disks; magneto-optical disks; and CD-ROM, DVD+/-R, DVD-RAM, and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), or plasma monitor, for displaying information to the user and a keyboard and a pointing device, e.g., a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of wireline and/or wireless digital data communication, e.g., a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n and/or 802.20, all or a portion of the Internet, and/or any other communication system or systems at one or more locations. The network may communicate with, for example, Internet Protocol (IP) packets, Frame Relay frames, Asynchronous Transfer Mode (ATM) cells, voice, video, data, and/or other suitable information between network addresses.

The computing system can include clients and servers. A client and server are generally remote from each other and typically interact through a communication network. The relationship of client and server arises by virtue of computer programs running on the respective computers and having a client-server relationship to each other.

In some implementations, any or all of the components of the computing system, both hardware and/or software, may interface with each other and/or the interface using an application programming interface (API) and/or a service layer. The API may include specifications for routines, data structures, and object classes. The API may be either computer language independent or dependent and refer to a complete interface, a single function, or even a set of APIs. The service layer provides software services to the computing system. The functionality of the various components of the computing system may be accessible for all service consumers via this service layer. Software services provide reusable, defined business functionalities through a defined interface. For example, the interface may be software written in JAVA, C++, or other suitable language providing data in extensible markup language (XML) format or other suitable format. The API and/or service layer may be an integral and/or a stand-alone component in relation to other components of the computing system. Moreover, any or all parts of the service layer may be implemented as child or sub-modules of another software module, enterprise application, or hardware module without departing from the scope of this disclosure.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation and/or integration of various system modules and components in the implementations described above should not be understood as requiring such separation and/or integration in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

What is claimed is:

1. A computer-implemented method comprising:
processing, by operation of a computer, a hierarchy of container documents including a base-level container document and at least one active base-level content hyperlink and additional container documents associated with the at least one active base-level content hyperlink to:
generate a container document site map specifying the hierarchy of container documents; and
associate at least one generated graphical user interface (GUI) element with each container document in the hierarchy of container documents specified by the site map;
receiving a hover detection event associated with the at least one active base-level content hyperlink;
displaying a first-level pop-up container document including at least one first-level GUI element representing a particular additional container document associated with the one active base-level content hyperlink; and
displaying a first-level detailed pop-up container document responsive to a detected hover event associated with one of the at least one first-level GUI element.

2. The method of claim 1, wherein the particular additional container document is at a lower hierarchy level in the container document site map than the base-level container document.

3. The method of claim 1, wherein metrics data associated with a source of a detected particular hover event is updated responsive to the detected particular hover event.

4. The method of claim 1, wherein the first-level detailed pop-up container document includes a reduced-size representation of a first container document associated with the at least one first-level GUI element.

5. The method of claim 4, wherein the reduced-size representation contains at least one active second-level content hyperlink to a second container document at a lower hierarchy level in the container document site map than the first container document associated with the reduced size representation.

6. The method of claim 5, further comprising displaying a second pop-up container document responsive to a received hover event associated with the at least one active second-level content hyperlink, wherein the second pop-up container document includes at least one second level GUI element.

7. The method of claim 6, wherein a particular GUI element associated with a first particular level pop-up container document is movable to a second particular level pop-up container document, and wherein the first particular level and the second particular level are different.

8. The method of claim 7, wherein moving the GUI element associated with the first particular level pop-up container document to the second particular level pop-up container document generates a request to restructure the container document site map.

9. The method of claim 8, further comprising updating metrics data associated with the GUI element responsive to moving the GUI element.

10. The method of claim 9, further comprising determining that the container document site map should be restructured based upon the updated metrics data.

11. The method of claim 10, wherein the determination is based upon at least one updated value of the metrics data exceeding a threshold value.

12. The method of claim 11, further comprising:
reprocessing the hierarchy of container documents; and
generating an updated container document site map.

13. A non-transitory, computer-readable medium storing computer-readable instructions executable by a computer to:
process a hierarchy of container documents including a base-level container document and at least one active base-level content hyperlink and additional container documents associated with the at least one active base-level content hyperlink to:
generate a container document site map specifying the hierarchy of container documents; and
associate at least one generated graphical user interface (GUI) element with each container document in the hierarchy of container documents specified by the site map;
receive a hover detection event associated with the at least one active base-level content hyperlink;
display a first-level pop-up container document including at least one first-level GUI element representing a particular additional container document associated with the one active base-level content hyperlink; and
display a first-level detailed pop-up container document responsive to a detected hover event associated with one of the at least one first-level GUI element.

14. The medium of claim 13, wherein the particular additional container document is at a lower hierarchy level in the container document site map than the base-level container document.

15. The medium of claim 13, wherein metrics data associated with a source of a detected particular hover event is updated responsive to the detected particular hover event.

16. The medium of claim 13, wherein the first-level detailed pop-up container document includes a reduced-size representation of a first container document associated with the at least one first-level GUI element.

17. The medium of claim 16, wherein the reduced-size representation contains at least one active second-level content hyperlink to a second container document at a lower hierarchy level in the container document site map than the first container document associated with the reduced size representation.

18. The medium of claim 17, further comprising instructions to display a second pop-up container document responsive to a received hover event associated with the at least one active second-level content hyperlink, wherein the second pop-up container document includes at least one second level GUI element.

19. The medium of claim 18, wherein a particular GUI element associated with a first particular level pop-up container document is movable to a second particular level pop-up container document, and wherein the first particular level and the second particular level are different.

20. The medium of claim 19, wherein moving the GUI element associated with the first particular level pop-up container document to the second particular level pop-up container document generates a request to restructure the container document site map.

21. The medium of claim 20, further comprising instructions to update metrics data associated with the GUI element responsive to moving the GUI element.

22. The medium of claim 21, further comprising instructions to determine that the container document site map should be restructured based upon the updated metrics data.

23. The medium of claim 22, wherein the determination is based upon at least one updated value of the metrics data exceeding a threshold value.

24. The medium of claim 23, further comprising instructions to:
reprocess the hierarchy of container documents; and
generate an updated container document site map.

25. A computer system, comprising:
at least one computer configured to:
process a hierarchy of container documents including a base-level container document and at least one active base-level content hyperlink and additional container documents associated with the at least one active base-level content hyperlink to:
generate a container document site map specifying the hierarchy of container documents; and
associate at least one generated graphical user interface (GUI) element with each container document in the hierarchy of container documents specified by the site map;
receive a hover detection event associated with the at least one active base-level content hyperlink;
display a first-level pop-up container document including at least one first-level GUI element representing a particular additional container document associated with the one active base-level content hyperlink; and
display a first-level detailed pop-up container document responsive to a detected hover event associated with one of the at least one first-level GUI element.

26. The system of claim 25, wherein the particular additional container document is at a lower hierarchy level in the container document site map than the base-level container document.

27. The system of claim 25, wherein metrics data associated with a source of a detected particular hover event is updated responsive to the detected particular hover event.

28. The system of claim 25, wherein the first-level detailed pop-up container document includes a reduced-size representation of a first container document associated with the at least one first-level GUI element.

29. The system of claim 28, wherein the reduced-size representation contains at least one active second-level content hyperlink to a second container document at a lower hierarchy level in the container document site map than the first container document associated with the reduced size representation.

30. The system of claim 29, further comprising instructions to display a second pop-up container document responsive to a received hover event associated with the at least one active second-level content hyperlink, wherein the second pop-up container document includes at least one second level GUI element.

31. The system of claim 30, wherein a particular GUI element associated with a first particular level pop-up container document is movable to a second particular level pop-up container document, and wherein the first particular level and the second particular level are different.

32. The system of claim 31, wherein moving the GUI element associated with the first particular level pop-up container document to the second particular level pop-up container document generates a request to restructure the container document site map.

33. The system of claim 32, further configured to update metrics data associated with the GUI element responsive to moving the GUI element.

34. The system of claim 33, further configured to determine that the container document site map should be restructured based upon the updated metrics data.

35. The system of claim 34, wherein the determination is based upon at least one updated value of the metrics data exceeding a threshold value.

36. The system of claim 35, further configured to:
reprocess the hierarchy of container documents; and
generate an updated container document site map.
